(19) United States
(12) Patent Application Publication
(10) Pub. No.: US 2016/0308386 A1
(43) Pub. Date: Oct. 20, 2016

(54) RECHARGEABLE HEARING AID AND CHARGING SYSTEM THEREFOR

(71) Applicant: IMHear Corporation, Downers Grove, IL (US)

(72) Inventors: Hanze Tang, Xiamen City (CN); Chengyu Li, Ningde City (CN); Shihu Yu, Xiamen City (CN)

(73) Assignee: IMHear Corporation, Downers Grove, IL (US)

(21) Appl. No.: 15/065,525

(22) Filed: Mar. 9, 2016

Related U.S. Application Data
(60) Provisional application No. 62/133,063, filed on Mar. 13, 2015.

(51) Int. Cl. H02J 7/02; H04R 25/00; H02J 7/04

(52) U.S. Cl. CPC H02J 7/027; H02J 7/025; H02J 7/047; H04R 25/305; H04R 25/602; H04R 2225/31; H04R 2225/33

(57) ABSTRACT

A rechargeable hearing aid including an internal power unit such as a lithium ion battery having a short recharging time and a portable hearing aid charging and protection system for charging it. The charging system includes a protection system to prevent overheating and overcharging of the battery, an interface apparatus such as a Micro-USB connector, an induction charging device, a wireless induction charging device, or other suitable charging system interface apparatus to uniquely couple a charging power source, the charging and protection system and the internal power unit together. Among other features, the charging system communicates with the hearing aid to protect it by automatically turning off the hearing aid power while charging the hearing aid battery, turning the hearing aid power back on when charging is complete, and stepping the normal output voltage of the power unit down to the much lower operating voltage of the hearing aid.

### CROSS REFERENCE TO RELATED APPLICATIONS

This application claims priority to U.S. Provisional Patent Application Ser. No. 62/133,063 filed Mar. 13, 2015, the entire disclosure of which is incorporated herein by reference.

### FIELD OF THE INVENTION

The present invention relates to a rechargeable hearing aid. More specifically, the present invention relates to a rechargeable hearing aid and a charging and protection system for charging the hearing aid.

### BACKGROUND OF THE INVENTION

Over 95% of the hearing aids in the current marketplace use disposable batteries, which require frequent replacement by the hearing aid user. Replacing hearing aid batteries is a time consuming, expensive and frustrating process, not only due to the relatively small size of such batteries (a No. 10 battery is smaller than the end of a pencil, approximately 4 mm in diameter and 2.5 mm thick), but also due to the physical limitations of a typical hearing aid wearer. A person suffering from hearing loss may be in his or her senior years and suffer from failing eyesight, arthritis, tremors, lack of dexterity and other peripheral neuropathic conditions that render handling a small object of hearing aid battery-size difficult, if not impossible.

Hearing aid battery life is not easily predictable, inasmuch as it may depend upon usage, individual hearing aid power requirements, temperature, environment and other conditions of use. Accordingly, generally a user will not know when the battery in his or her hearing device will require changing. In many instances, a “low battery” alert function may be the first and only indication a wearer will receive that a replacement is needed. This can occur in the most inconvenient of situations, for example, in a business meeting, a restaurant or a theater where not only the wearer's ability to participate in and enjoy the activity is interrupted, but lighting conditions may be so subdued that the wearer may have to simply remove the hearing device until a more opportune time for changing the battery arises. Loss of the sound amplification and hearing assistance provided by the hearing aid when the battery dies will result if the wearer does not replace the battery in a short period of time following the alert. Moreover, under such circumstances, proper disposal of the exhausted battery will be an issue. It is estimated that over 15 billion disposable hearing aid batteries are consumed world-wide annually. One can only imagine the adverse environmental impact that improper recycling of these materials is having globally.

Hearing aids employing rechargeable batteries have been known in the art for some time. Some initial versions, nonetheless, still required that the battery be removed for recharging and then be reinstalled in the hearing aid. However, may hearing aids used sealed NiCad batteries, which required that the whole hearing aid be returned for servicing. Thus, the aforementioned problems associated with physical manipulation of the battery were not addressed. Subsequent advances in hearing aid and battery technology led to the development of hearing aids having rechargeable batteries that did not have to be removed for charging. For example, the hearing aid recharging system disclosed in U.S. Pat. No. 4,379,988 issued to Mattatall employs an inductive charging system to recharge a hearing aid battery without having to remove it from the device. More recently, U.S. Patent Application Publication No. US 2014/0153759 A1, published by Cantin on Jun. 5, 2014, discloses an induction recharging system for a rechargeable in-the-ear hearing aid. Cantin's apparatus eliminates the need to remove the hearing aid battery for recharging. However, the recharging system of Cantin's design does not address the problems associated with battery memory or overcharging, problems arising from the naturally occurring phenomenon of hysteresis. Hysteresis is the dependence of the output of a system not only on its current input, but also on its history of past inputs. The dependence arises because the history affects the value of an internal state. To predict its future outputs, either its internal state or its history must be known.

U.S. Pat. No. 7,620,195, issued Nov. 17, 2009 to Bradley et al. for a Rechargeable Hearing Aid (the '195 patent), discloses a rechargeable hearing aid and induction recharging system that provides acoustic communication between the hearing aid and the charger to prevent overcharging. However, the hearing aid device and recharging system disclosed in the 195 patent uses a nickel-metal-hydride (NiMH) battery, which requires a relatively long charging time (approximately six or more hours) and a customized charger, which is not convenient to transport while travelling or to replace should one lose it or fail to pack it for travel.

In view of the foregoing, it will be apparent to those skilled in the art that a need exists for an improved rechargeable hearing aid and charging system that is readily transportable, does not require battery removal from the hearing aid for recharging, provides extended hours of battery usage and a large number of recharging cycles before replacement, and provides programmable control over the charging process to prevent overheating and overcharging of the battery.

### SUMMARY OF THE INVENTION

In an embodiment, the hearing aid battery recharging system of the present invention addresses the aforementioned problems associated with the prior art by providing a portable hearing aid charging and protection system for recharging a rechargeable hearing aid using a lithium ion battery having a short recharging time. The recharging system including a protection system to prevent overheating and overcharging of the battery, an interface apparatus for coupling a power source to the charging and protection system such as a Micro-USB connector, an induction interface system, a wireless induction interface system, or other suitable charging system coupling or interface apparatus to uniquely connect a power source to the hearing aid charging and protection system and the battery so that, among other features, the charging system will communicate with the hearing aid to protect it by automatically turning off the hearing aid power while charging and turning the hearing aid power back on when charging is complete.

These and other features of the present invention will be apparent from the accompanying drawings, detailed description of the invention and the appended claims. As will be realized, the present invention is capable of modifications in various aspects, all without departing from the spirit and scope of the instant disclosure. While various embodiments are disclosed, still other embodiments will become apparent to those skilled in the art from the following detailed description and drawings which are to be regarded as illustrative in nature and not restrictive.

### BRIEF DESCRIPTION OF THE DRAWINGS

FIG. 1 is a side perspective view of a rechargeable hearing aid in accordance with an embodiment of the present invention;

FIG. 2 is an exploded side elevation view of the rechargeable hearing aid of FIG. 1 which is expanded to show the elements thereof in greater detail;

FIG. 3 is a side elevation sectional view of the operational components of the rechargeable hearing aid of FIGS. 1 and 2 having the housing removed to show the internal operational components thereof in greater detail;

FIG. 4 is a side elevation sectional view a rechargeable hearing aid in accordance with an embodiment;

FIG. 5 is a side elevation sectional view of a rechargeable hearing aid and a Micro-USB connector in accordance with and embodiment;

FIG. 6.A. is a circuit diagram of the common Micro USB charging interface portion of the rechargeable hearing aid charging protection circuit in accordance with an embodiment;

FIG. 6.B. is a circuit diagram of the charging control circuit portion of the rechargeable hearing aid charging protection circuit in accordance with an embodiment;

FIG. 6.C. is a circuit diagram of the charging protection circuit portion of the rechargeable hearing aid charging protection circuit in accordance with an embodiment;

FIG. 6.D. is a circuit diagram of the automatic switch-off circuit portion of the rechargeable hearing aid charging protection circuit in accordance with an embodiment;

FIG. 6.E. is a circuit diagram of the voltage transfer circuit portion of the rechargeable hearing aid charging protection circuit in accordance with an embodiment;

FIG. 7.A. is an enlarged view of a portion of a battery recharging control circuit in accordance with an embodiment;

FIG. 7.B. is a continuation of the enlarged view of the remaining portion of the battery recharging control circuit of FIG. 7.A. in accordance with an embodiment.

FIG. 8 is a side perspective view of a rechargeable lithium polymer battery hearing aid power supply in accordance with an embodiment;

FIG. 9 is a side elevation view of the power supply of FIGS. 7.A. and 7.B.;

FIG. 10 is a top plan view of the power supply of FIGS. 7.A., 7.B., and 8;

FIG. 11 is a bottom view of the power supply of FIGS. 7.A, 7.B., 8, and 9;

FIG. 12 is a flexible printed circuit board for managing the charging process for charging the power supply illustrated in FIGS. 8-11 in accordance with an embodiment;

### DETAILED DESCRIPTION OF THE INVENTION

It should be noted that the present description is by way of illustration only, and that the concepts and examples presented herein are not limited to use or application with any single rechargeable hearing aid and recharging system. Hence, while the details of the rechargeable hearing aid and the recharging system and its components described herein are for the convenience of illustration and explanation with respect to the exemplary embodiments, the principles disclosed may be applied to other types of hearing aids and recharging systems without departing from the scope of the present invention.

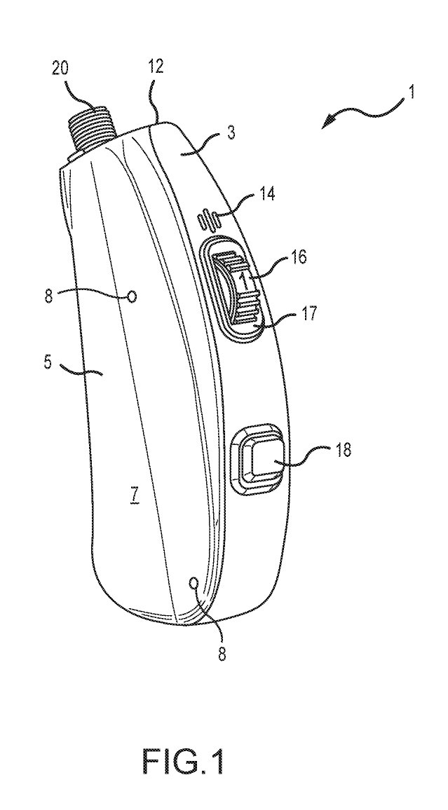

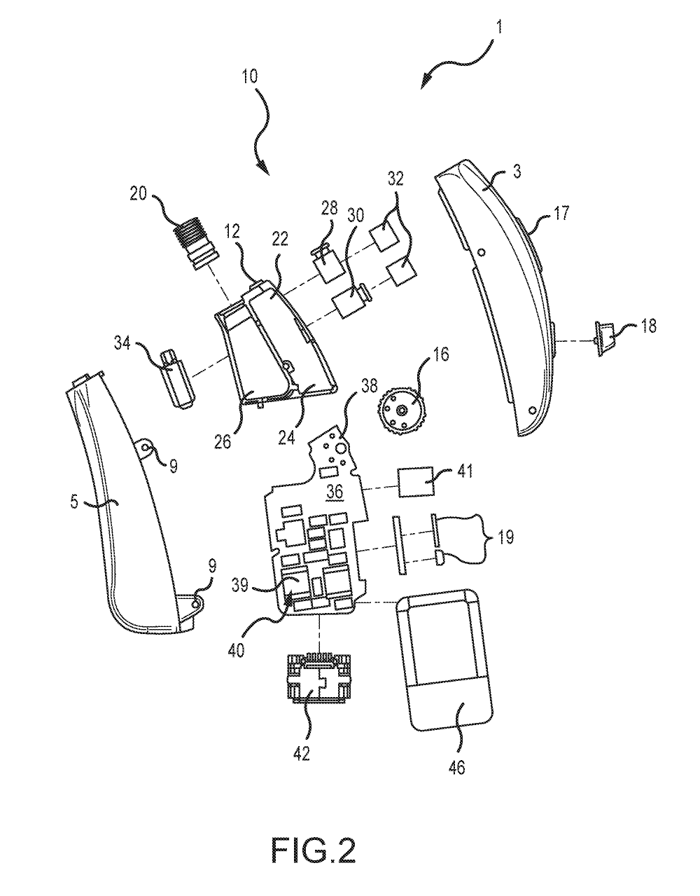

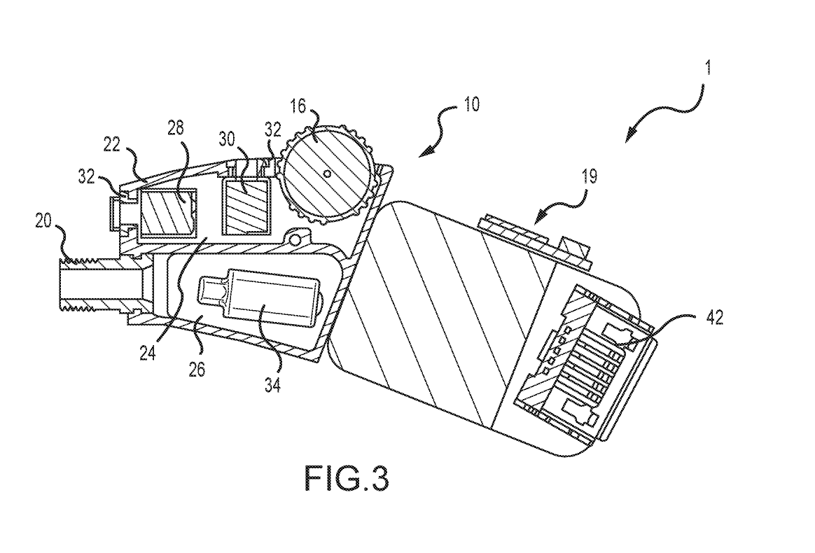

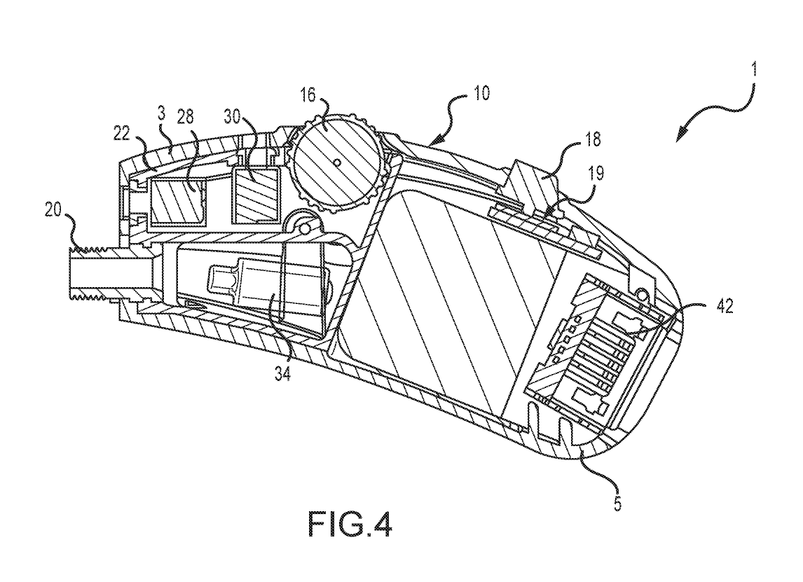

Referring now to FIG. 1, a rechargeable hearing aid in accordance with an embodiment of the instant invention is shown generally at 1. The hearing aid includes a first housing or upper case cover 3, a second housing or lower case cover 5, the first and second case covers being structured and arranged to operatively engage one another to form an enclosure 7 to protect the internal operating components of the hearing aid, which are shown generally at 10 in FIGS. 2-5. The covers are retained in position by suitable fasteners such as retention screws or pins (not shown) which each extend through an aperture 8 formed in the upper case cove 3 attach to a respective retainer bracket 9 connected to the lower case cover 5. The rechargeable hearing aid further includes a front microphone port 12, a rear microphone port 14, a volume control 16 extending through an aperture or slot 17 in the upper cover 3 and being operatively connected to a potentiometer 38 for controlling the volume directed into a wearer's ear, and a push button control 18 to select and activate control buttons 19 and various programs in the hearing aid. A threaded stem 20 is adapted to receive a sound tube (not shown) extending from the hearing aid enclosure 7 into a wearer's ear canal.

As more clearly shown in FIGS. 2-4, the enclosure 7 contains a support structure or frame 22 mounted internally therein, the enclosure being divided into two chambers or cavities 24 and 26. Cavity 24 is adapted to receive dual front and rear microphones 28 and 30 respectively, each extending through isolation tubes 32 positioned in the apertures 12 and 14 respectively formed in the upper case cover 3. A speaker/transducer 34 is mounted in cavity 26 to transform electronic energy into acoustic energy and to direct the acoustic energy via stem 20 to a sound tube extending into a wearer's ear canal as described above.

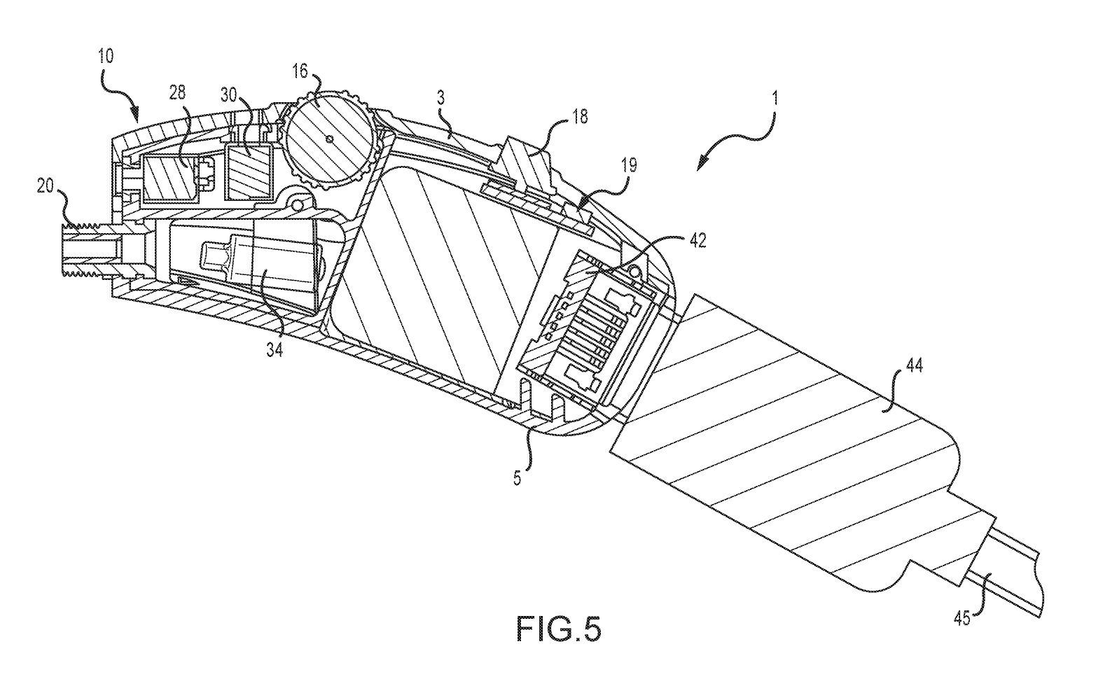

As best shown in FIG. 2, circuit board 36 is mounted within case covers 3, 5 and includes wiper/potentiometer 38 mounted thereon and adapted to cooperate with volume control 16 to adjust the hearing aid volume. A recharging control system circuit or chip, shown generally at 40, is mounted on board 36 adjacent the potentiometer and includes the functional components of the battery recharging control circuit, including a digital signal processor (DSP) 41, all of which will be described in greater detail below, an interface device or apparatus, by way of example, a universal charging cord interface 42 for a Micro-USB connector and attached charging cord (shown as 44 and 45 respectively in FIG. 5) and a rechargeable power unit or battery 46. It is to be understood, however, that other interface devices such as induction, wireless induction or other suitable interface coupling apparatus may be used without departing from the scope of the present invention. As will be described in greater detail below, by way of illustration and not of limitation, the rechargeable power unit may preferably be in the form of a lithium polymer battery; however, it is to be understood that other suitable power units may be used without departing from the scope of the present invention.

Micro-USB cables are readily available, may be transported easily, and permit connection to any computer or via an adaptor to a standard electrical outlet, so that a wearer of the novel hearing aid of the present invention may quickly and conveniently recharge its battery or batteries at virtually any location. In a preferred embodiment, the battery is a high strength, lithium ion or lithium polymer battery which may be recharged fully in approximately ninety minutes, much more quickly than conventional prior art rechargeable hearing aids.

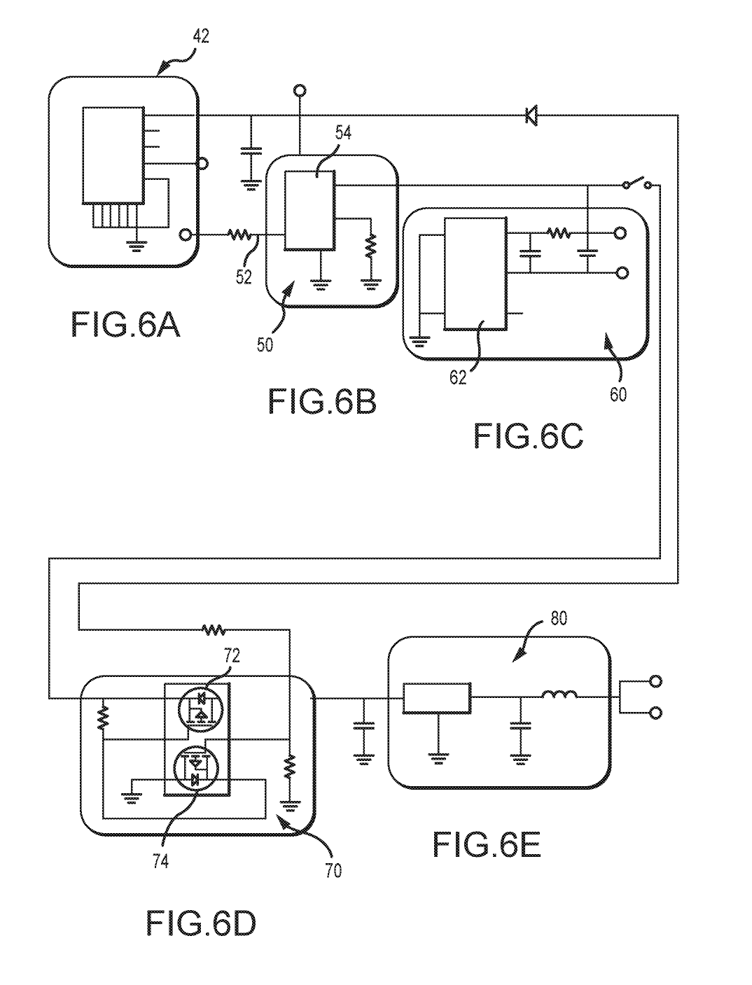

Referring now to FIGS. 6.A.-6.E., the circuit diagrams of the elements of the recharging control system are illustrated in greater detail. FIG. 6.A. outlines the specifics of the universal Micro-USB interface 42 located inside the hearing aid housing, which permits the hearing aid wearer to recharge its battery as easily as he or she would recharge a cell phone. Interface 42 is a conventional Micro-USB interface found on most computers and laptops which is adapted to receive the standard Micro-USB connector attached to one end of the charging cord 45. The other end of the charging cord may have either a second Micro-USB connector attached thereto for charging the hearing aid from the user's computer or a portable recharging device. Alternatively, the cord may include a standard two-prong wall plug attachment for charging from an electrical wall outlet, thereby making the hearing aid as easy for the user to recharge as his or her mobile telephone.

FIG. 6.B. depicts the circuit elements of a charging control circuit module 50, which is operatively connected to USB interface 42 via input line 52. Charging control module 50 includes microprocessor or digital signal processor (“DSP”) 54 which monitors and controls the charging current so that the battery recharging cycle is fast and stable without generating excessive heat. This circuit permits a full battery recharge within ninety (90) to one hundred twenty (120) minutes, a significant improvement over prior art recharging cycles of six hours or longer.

A charging protection circuit module 60 is shown in FIG. 6.C. The protection circuit module includes microprocessor 62 which monitors the charging process, the charging current magnitude and the level of battery charge from moment to moment during the charging process to protect the battery against over-charging, over-current surges and short circuiting in the system.

FIG. 6.D. is a circuit diagram of an automatic power switch off circuit module 70. Comprising at least one each of a conventional electronic sensing element and a switching element as known in the art, such as transistors 72, 74, this module senses or detects the initiation of the charging process and automatically switches off the power of the hearing aid system so that, for example, the hearing aid will not emit any sound or noise during the charging process. This feature is particularly attractive to a user who recharges the hearing aid battery at night during normal sleeping hours.

Referring to FIG. 6.E., the specifics of a voltage stabilizing circuit are shown in the circuit diagram. Effectively a transformer, this circuit module steps down the operating voltage of the power supply (the battery) from its conventional operating voltage of approximately 3.3 volts to a stable 1.4 volts, which is typically the maximum conventional operating voltage for the hearing aid system

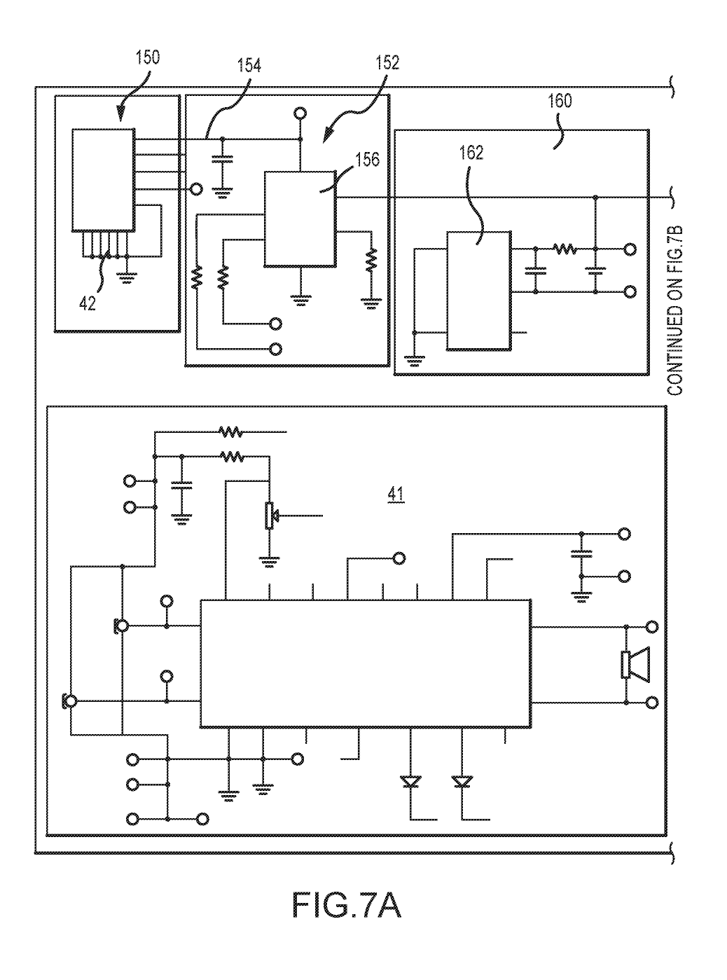

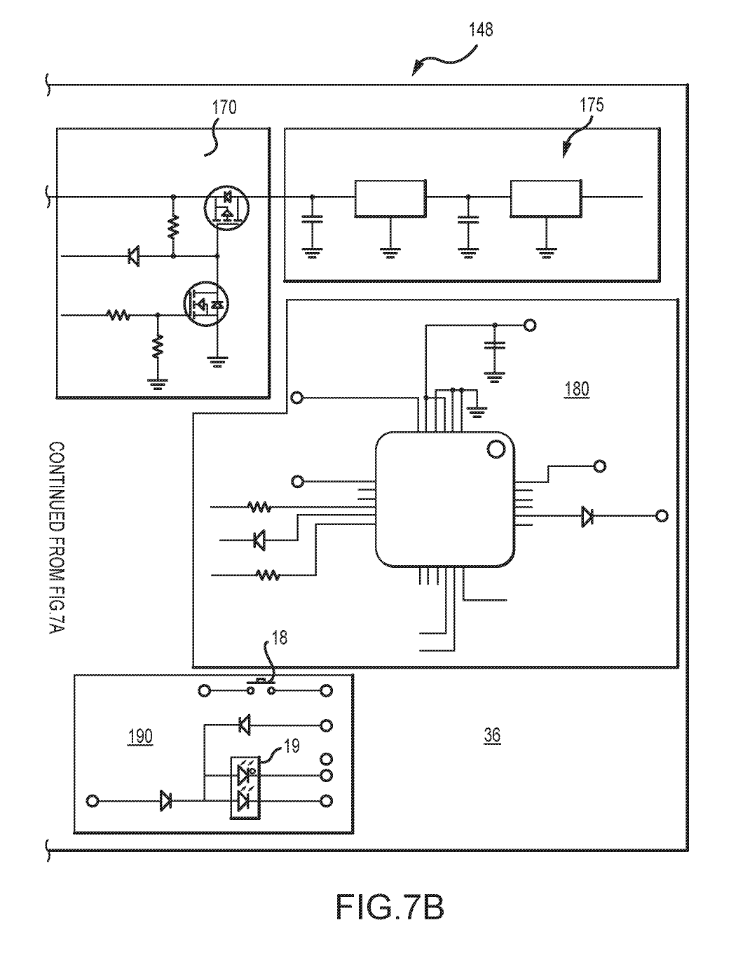

FIGS. 7.A. and 7.B. illustrate an enlarged circuit diagram of the elements of a recharging control system of the present invention in accordance with an embodiment 148 thereof. The control system 148 described below in accordance with an embodiment corresponds to the recharging control system or chip 39 mounted on board 36 shown in FIG. 2. The system includes module 150 which illustrates the specifics of the exemplary universal Micro-USB interface 42 located inside the hearing aid housing. As described above with respect to the embodiment of FIG. 6, interface 42 is a conventional Micro-USB interface found on most computers and laptops which is adapted to receive the standard Micro-USB connector attached to one end of the charging cord 45. The other end of the charging cord may have either a second Micro-USB connector attached thereto for charging the hearing aid from the user's computer or a portable recharging device.

A charging manager element 152 is electrically coupled to the Miro USB interface 150 via connector 154. Charging control module 50 includes microprocessor or digital signal processor (“DSP”) 156 which monitors and controls the charging current so that the battery recharging cycle is fast and stable without generating excessive heat.

The charging control system of the embodiment of FIGS. 7.A. and 7.B. further includes a battery protection circuit module 160, which, like the charging protect circuit module 60 of the embodiment of FIG. 6, includes a microprocessor 162 which monitors the charging process, the charging current magnitude and the level of battery charge from moment to moment during the charging process to protect the battery against over-charging, over-current surges and short circuiting in the system. The battery protection module is connected directly to an On-Off switch 170 and is structured and arranged to selectively turn the recharging control system on or off, the On-Off switch 170 being electrically connected to a voltage stabilizing module 175. The voltage stabilizing module steps down the operating voltage of the power supply (the battery) from its conventional operating voltage of approximately 3.3 volts to a stable 1.4 volts, which is typically the maximum conventional operating voltage for the hearing aid system.

Microcontroller or MCU controller 180 is mounted on board 36 and comprises electronic circuit control elements known in the art that are structured and arranged to monitor and control the recharging control system 148 via the hearing aid digital signal processor 41 (also shown in FIG. 2), and module 190 illustrates the elements of the push button control 18 and control buttons 19 shown in FIG. 2 and LED on-off and charging indicators (not shown) of the system.

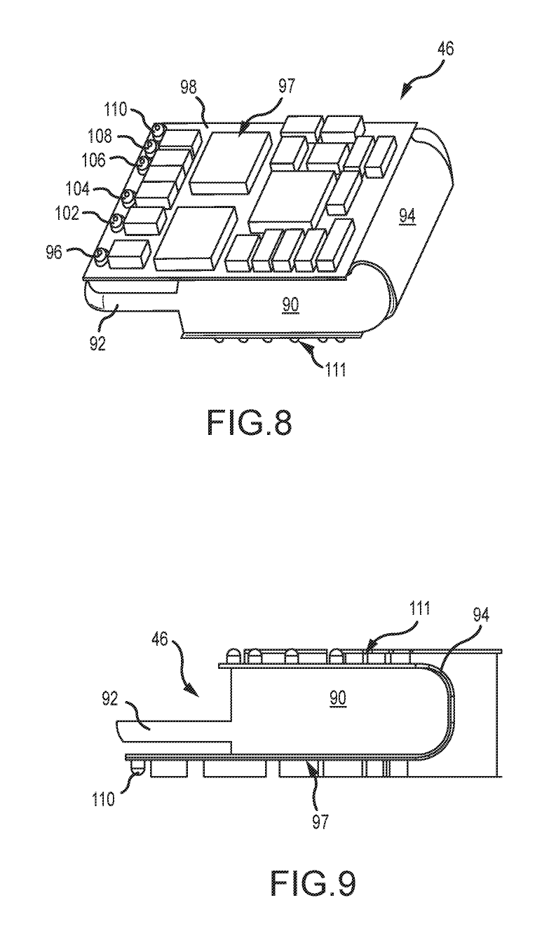

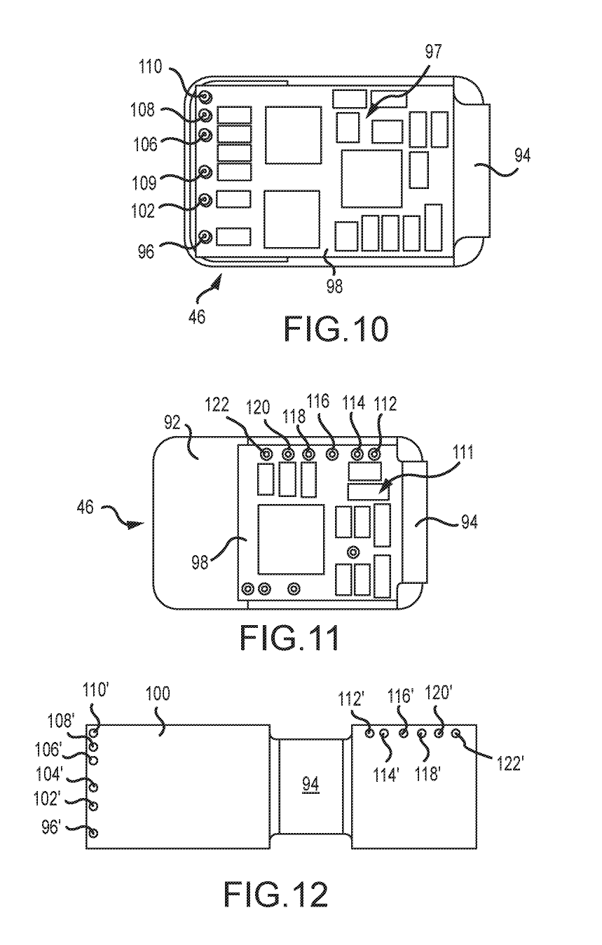

The rechargeable lithium ion battery hearing aid power supply 46 of the present invention is shown in greater detail in FIGS. 8-11. As best shown in FIG. 8, the power supply or battery 46 includes a housing 90 having an extension or tongue portion 92 extending laterally outwardly therefrom and adapted to be received in releasable engagement in a mating receptacle portion (not shown) in the hearing aid housing to facilitate replacement when the battery has exhausted its useful life.

A flexible printed circuit board (“PCB”) 94 (illustrated in an extended view in FIG. 12) having the elements of the circuitry of the recharging control system embodiment shown in FIGS. 6.A.-6.E., or, alternatively, the embodiment of FIGS. 7.A. and 7.B., is shown in position on and extending around the battery 46 as it would be during charging mode. The circuit board includes a terminal or connector 96 secured to an upper portion 97 of a first or exterior side 98 of the PCB 94 and adapted to be connected to a positive terminal or pole of the battery via connector 96 on an opposite or interior side 100 of the circuit board 94. For purposes of simplicity, each of the plurality of terminals or connectors will be described below in connection with a corresponding terminal or connector having the same number and positioned on the interior side of the PCB as shown in FIG. 12. Similarly located, connector 102 operatively connects to a negative terminal or pole pf the battery via connector 102′; connector 104 operatively connects to a charging indicator, for example a red LED light, via terminal 104′; connector 106 operatively connects to a charging complete indicator, for example, a green LED light, via terminal or connector 106′; connector 108 operatively connects to a negative terminal in the universal Micro-USB interface 42 located inside the hearing aid housing via connector 108′; and terminal or connector 110 operatively connects to a positive terminal in the universal Micro-USB interface via connector 110′.

Referring now to both FIGS. 11 and 12, a plurality of terminals or connectors positioned on a lower portion 111 of the exterior side 98 of the PCB 94 is shown. The plurality of terminals includes terminal 112 operatively connected to a ground terminal on the microprocessor 54 via terminal 112′ positioned on the interior side 100 of the circuit board 94; terminal 114 operatively connected to a voltage; control circuit component of the microprocessor via terminal 114′; a power terminal 116 electrically coupled via terminal 116′ to a power control actuator (not shown) to turn the system on and off; an automatic temperature control/temperature switch terminal 118 connected via terminal 118′ to the automatic temperature control portion of the microprocessor; switch connector 120 which connects to the switch pin of the microprocessor via terminal 120′; and terminal 122 which is electrically connected to the direct audio input terminal (DAI terminal, an optional hearing aid feature), of the microprocessor via terminal 122′.

Changes may be made in the above methods, devices and structures without departing from the scope hereof. It should thus be noted that the matter contained in the above description and/or shown in the accompanying drawings should be interpreted as illustrative and not in a limiting sense. The following claims are intended to cover all generic and specific features described herein, as well as all statements of the scope of the present method, device and structure, which, as a matter of language, might be said to fall there between.

What is claimed is:

1. A charging and protection system for a rechargeable hearing aid, the hearing aid including a housing structured and arranged to enclose a rechargeable power unit, internal operating components of the hearing aid, the charging and protection system being located within the housing in electrical communication with the power unit and an external power source, the charging and protection system comprising:
an interface apparatus for coupling the external power source to the charging and protection system;
a charging control circuit module operatively connected to the interface apparatus;
a charging protection circuit module;
an automatic power switch off circuit module structured and arranged to detect the initiation of the charging process and to switch off the hearing aid in response to the initiation of the charging process; and
a voltage stabilizing module adapted to the operating voltage of the power unit from its conventional operating voltage to a lower conventional operating voltage for the hearing aid system.

2. The system of claim 1 wherein the interface apparatus comprises a Micro-USB connector.

3. The system of claim 1 wherein the interface apparatus comprises an induction charging device.

4. The system of claim 1 wherein the interface apparatus comprises a wireless induction charging device.

5. The system of claim 1 wherein the charging control circuit module includes a digital signal processor which is structured and arranged to monitor and control a charging current whereby heat generated by a charging cycle is controlled.

6. The system of claim 1 wherein charging protection circuit module includes a digital signal processor adapted to monitor the charging process, a charging current magnitude, and a level of power unit charge at any moment in the charging process whereby the power unit is protected against over-charging, over-current surges and short circuiting within the system.

7. The system of claim 1 wherein the automatic power switch off circuit module includes at least one sensing element adapted to detect the initiation of a charging process and at least one switching element which is structured and arranged to switch off hearing aid system power in response to detection of the initiation of a charging process.

8. The system of claim 1 wherein the power unit has an operating voltage, the hearing aid circuit has an operating voltage which is lower than the power supply operating voltage, and wherein the voltage stabilizing module is adapted to step down the operating voltage of the power supply to the lower operating voltage of the hearing aid circuit.

9. The system of claim 1 wherein the power unit comprises a rechargeable lithium ion battery.

10. The system of claim 8 wherein the power unit comprises a rechargeable lithium ion battery.

11. The system of claim 10 wherein the power unit operating voltage is in a range of 2.7 to 3.5 volts.

12. The system of claim 10 wherein the hearing aid circuit voltage is in a range of 1.3 to 1.5 volts.

13. The system of claim 11 wherein the hearing aid circuit voltage is in a range of 1.3 to 1.5 volts.

14. The system of claim 1 further including a charging indicator structured and arranged to indicate when the power unit is being charged.

15. The system of claim 1 further including an indicator which signals when the charging of the power unit is complete.

16. The system of claim 7 wherein the automatic power switch off circuit module is structured and arranged to arranged to switch on hearing aid system power in response to completion of the charging of the power unit.

17. The system of claim 14 wherein the charging indicator is an LED light.

18. The system of claim 15 wherein the signal which indicates completion of the charging of the power unit is an LED light.
